(19) United States
(12) Patent Application Publication
(10) Pub. No.: US 2013/0332591 A1
(43) Pub. Date: Dec. 12, 2013

(54) DYNAMIC SCRIPT INTERPRETATION IN REMOTE CONTEXTS

(71) Applicant: AVENTURA HQ, INC., Denver, CO (US)

(72) Inventors: Joe Jaudon, Sedalia, CO (US); David Lowrey, Denver, CO (US); Adam Williams, Aurora, CO (US)

(21) Appl. No.: 13/910,668

(22) Filed: Jun. 5, 2013

Related U.S. Application Data
(60) Provisional application No. 61/656,109, filed on Jun. 6, 2012.

(51) Int. Cl. H04L 29/06

(52) U.S. Cl. CPC H04L 29/06326
USPC 709/223

(57) ABSTRACT

Systems, devices, and methods for dynamically interpreting a script in a remote context are provided. A host device begins an interpretation of a script according to local context data of the host device. The script may be associated with a virtual session hosted by the host device on behalf of a terminal device communicatively coupled with the host computing device. The host device may recognize a language element in the script that indicates a portion of the script associated with interpretation according to local context data of the terminal device. The host device may receive results of an interpretation of the indicated portion of the script according to the local context data of the terminal device. The host device may continue interpreting the script according to the context data of the host computing device using the received results.

### CROSS-REFERENCE

The present invention claims priority to U.S. Provisional Application Ser. No. 61/656,109, filed on Jun. 6, 2012, which is incorporated herein by reference for all purposes.

### BACKGROUND

The present invention relates to the storage and interpretation of scripts at computing devices.

In some networks, a user logs in to a system by providing authentication credentials at a terminal device. Upon verification of the authentication credentials, a virtual session may be established at one or more host devices and associated with the user. The session allows the user to interact with system resources of the host device by sending and receiving session data at the terminal device. The use of virtual sessions may provide for the centralization and efficient distribution of processing resources. This centralization of resources may reduce the burden on system administrators with respect to updating and maintaining software resources, as well as increasing the security of the system.

Nevertheless, the use of virtual sessions may pose difficulties arising from different context data associated with the host device at which the virtual session is executed and the terminal device through which the user accesses the session data. For instance, a user of the session may wish to use the location of the terminal device instead of the location of the host device to perform certain functions in the session. In one example, a user at a terminal device may wish to print a document, but the virtual session may default to a printer that is associated with a location of the host device rather than a printer that is closer to the location of the terminal device. On the other hand, it may make sense to use context data local to the host device to perform other tasks related to the virtual session, such as submitting a bug or crash report to an administrator. Thus, there is a need to balance executing certain aspects of a virtual session in one context and other aspects of the virtual session in another context.

### SUMMARY

Methods, systems, and devices are described for dynamic script interpretation in local and remote contexts.

According to a first illustrative configuration, a system for managing virtual session may include a terminal device and a host device communicatively coupled with the terminal device over a network. The host device may be configured to begin interpreting a script according to local context data of the host device. The script may be associated with a virtual session hosted by the host device on behalf of the terminal device. The host device may be further configured to recognize a language element in the script, the language element indicating a portion of the script associated with script interpretation according to a local context of the terminal device, and to receive the results of an interpretation of the indicated portion of the script according to the local context data of the terminal device. The host device may be configured to continue interpreting the script according to the context data of the host computing device using the received results.

According to a second illustrative configuration, a method of managing virtual sessions may include beginning an interpretation of a script at a host device according to local context data of the host device, the script associated with a virtual session hosted by the host device on behalf of a terminal device communicatively coupled with the host computing device; recognizing a language element in the script at the host device, the language element indicating a portion of the script associated with interpretation according to local context data of the terminal device; receiving results of an interpretation of the indicated portion of the script according to the local context data of the terminal device; and continuing to interpret the script at the host device according to the context data of the host computing device using the received results.

According to a third illustrative configuration, a host device may include at least one processor and a memory communicatively coupled with the at least one processor. The memory may store code that, when executed by the at least one processor, causes the at least one processor to: begin interpreting a script according to local context data of the host device, the script associated with a virtual session hosted by the host device on behalf of a terminal device communicatively coupled with the host computing device; recognize a language element in the script, the language element indicating a portion of the script associated with interpretation according to local context data of the terminal device; receive results of an interpretation of the indicated portion of the script according to the local context data of the terminal device; and continue to interpret the script according to the context data of the host computing device using the received results.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example system including components configured according to various embodiments of the invention.

FIG. 2 is a block diagram of an example system including components configured according to various embodiments of the invention.

FIGS. 3A and 3B are block diagrams of an example system including components configured according to various embodiments of the invention.

FIGS. 4A and 4B are diagrams of example portions of a script associated with a virtual session according to various embodiments of the invention.

FIG. 5 is a block diagram of an illustrative interaction between a host device and a terminal device according to various embodiments of the invention.

FIG. 6 is a block diagram of an illustrative interaction between a host device and a terminal device according to various embodiments of the invention.

FIG. 7 is a block diagram of an illustrative host device according to various embodiments of the invention.

FIG. 8 is a block diagram of another illustrative host device according to various embodiments of the invention.

FIG. 9 is a flowchart diagram of an example method of dynamically interpreting a script in a remote context according to various embodiments of the invention.

FIG. 10 is a flowchart diagram of an example method of dynamically interpreting a script in a remote context according to various embodiments of the invention.

FIG. 11 is a flowchart diagram of an example method of dynamically interpreting a script in a remote context according to various embodiments of the invention.

FIG. 12 is a flowchart diagram of an example method of dynamically interpreting a script in a remote context according to various embodiments of the invention.

FIG. 13 is a schematic diagram that illustrates a representative device structure that may be used in various embodiments of the present invention.

### DETAILED DESCRIPTION OF THE INVENTION

Methods, systems, and devices are disclosed for dynamically interpreting a script according to a remote context associated with a remote device. A unique language element may be defined within the syntax of the script such that the language element associates a portion of the script with context of the remote device. For example, the language element may include a keyword which indicates that a portion of the script is to be interpreted within the context of the remote device. The host device may recognize the language element in the script and cause the remote device to interpret the indicated portion of the script in the context of the remote device.

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

As used herein, the term “virtual session” or “session” refers to a hosted session of a virtual computing environment associated with a particular user that may be accessed from one or more client devices other than the host. For example, a session may include a thin client session, a virtual application session, a virtual machine session, a virtual operating system session, and/or the like. As used herein, a session described as being “between” a host device and a terminal device refers to the exchange of data between the host device and the terminal device, where the data is related to the session hosted at the host device.

Systems, devices, methods, and software are described for dynamic remote context script interpretation in a system of networked devices.

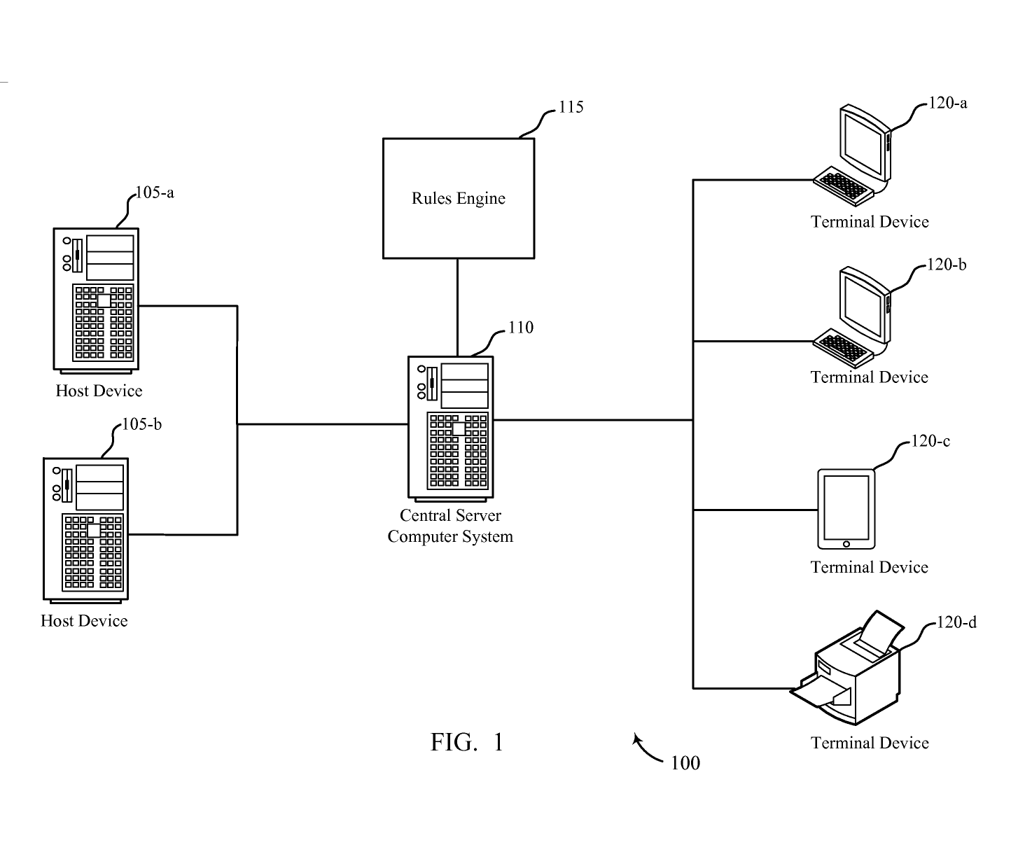

FIG. 1 illustrates an example system 100 including host devices 105, a central server computer system 110, a rules engine 115, and terminal devices 120 (e.g., workstation 120-a, workstation 120-b, smartphone 120-c, and printer 120-d). Each of these components may be in communication, directly or indirectly.

In the example of FIG. 1, the central server computer system 110 is communicatively coupled with a number of host devices 105 and terminal devices 120. The central server computer system 110 may be configured to forward network packets between the host devices 105 and the terminal devices 120. The central server computer system 110 may perform layer-3 switching (i.e., routing) and/or layer-2 switching. The central server computer system 110 may be implemented by a single server device or by a number of related components interconnected over a network.

Each of the host devices 105 may be configured to host one or more virtual sessions. In certain examples, each host device 105 may include one or more servers. Each of the sessions may be associated with a particular user. In certain examples, the central server computer system 110 may implement one or more host devices 105. A user may access a session hosted by a host device 105 through one of the terminal devices 120. In certain examples, a user may be a person. Alternatively, a user may be a process or a daemon running on one of the terminal devices 120. For example, one of the host devices 105 may host a session for a printing process on printer 120-d. In certain examples, the terminal device 120 may be a thin client, and the host device 105-a may provide operating system functionality remotely to the terminal device 120 while the terminal device 120 provides keyboard, video, and mouse (KVM) functionality for the session to the user. Alternatively, the terminal device 120 may execute the operating system based on settings provided for the user from the host device 105.

In one embodiment, a user of a terminal device 120 may log onto a system by providing authentication credentials (e.g., username, password, key card, biometric data, and/or other credentials) at the terminal device 120. The central server computer system 110 may forward the authentication credentials to a host device 105, which may authenticate the user and provide the terminal device 120 with access to operating system settings, programs, and files associated with the user over the network including the central server computer system 110.

In certain examples, the terminal devices 120 may directly establish virtual sessions at the host devices 105, and the central server computer system. Additionally or alternatively, the central server computer system 110 may arbitrate and maintain sessions at the host devices 105 on behalf of users of the terminal devices 120. Thus, when a user logs in to a system by providing authentication credentials at the terminal device 120, the central server computer system 110 may receive the authentication credentials and initiate a session between the host device 105 and the central server computer system 110 on behalf of the user using the authentication credentials. In certain examples, the central server computer system 110 may directly negotiate the session with the host device 105 such that the host device 105 addresses data for the session directly to the central server computer system 110 and is agnostic of the identity of the terminal device 120 associated with the user. Once a session has been established, the central server computer system 110 may forward session data received from the host device 105 (e.g., user interface video and/or audio data) to the terminal device 120. Additionally, the central server computer system 110 may forward session data received form the terminal device 120 (e.g., user interface input) to the host device 105. Thus, the terminal device 120 may act as though it has a direct connection with the host device 105, even though the session hosted by the host device 105 is really with the central server computer system 110. In certain examples, the session data may include keyboard, video and mouse (KVM) and/or related peripheral input/output data. Additionally or alternatively, the session data may include operating system settings, programs, and/or files associated with the user.

The central server computer system 110 may keep a session associated with a user active without regard to whether the user is currently logged in to a terminal device 120. When the user is logged in to a terminal device 120, the central server computer system 110 may switch session data between the terminal device 120 and the host device 105. When the user is not logged in to a terminal device 120, the central server computer system 110 may continue communications with the host device 105 to maintain the session. Because sessions hosted by the host devices 105 are kept active at the central server computer system 110 rather than at the terminal devices 120, there is no need to initialize a new session each time the user logs onto a different terminal device 120. Rather, the central server computer system 110 may dynamically switch session data for a particular session between different terminal devices 120 according to the movements of the user. Additionally, the fact that the central server computer system 110, rather than the terminal devices, maintains the sessions allows the central server computer system 110 to multiplex session data to multiple terminal devices 120 simultaneously.

The central server computer system 110 may communicate with the rules engine 115 to determine the proper network destination(s) for session data associated with various sessions hosted by the host devices 105. In certain examples, at least a portion of the rules engine 115 may be implemented by or within the central server computer system 110. Additionally or alternatively, at least a portion of the rules engine 115 may be implemented by a device external to the central server computer system 110. The rules engine 115 may apply or enforce a set of event-based rules for multiplexing the session data between the host devices 105 and the terminal devices 120. The central server computer system 110 may selectively forward session data between the host devices 105 and the terminal devices 120 based on the logical deductions of the rules engine 115.

When a user accesses a virtual session hosted by a host device 105 through a terminal device 120, the host device may interpret one or more scripts associated with the session to update the script or to perform various elements of functionality associated with the session. For example, when the user first logs on to the terminal device 120, the host device 105 may interpret a script in the session associated with the user to determine a default printer for the session. The script may include a number of instructions to be performed in the context of the host device (e.g., using local variables, resource allocation, etc.).

However, the script may also include instructions designed to be interpreted within the context of the terminal device 120. For example, an instruction to determine and set a default printer for the session may be specific to a location associated with the session. If interpreted in the context of the terminal device 120, a printer near the terminal device 120 may be selected as default. On the other hand, if the instruction is interpreted in the context of the host device 105, a printer near the host device 105 and far away from the user may be set as the default printer.

To address these issues, the host device 105 may be configured to interpret scripts according to the local context data of the host device by default. In the event that the host device 105, during the course of interpreting a script, recognizes a language element in the script indicating a portion of the script to be interpreted according to a different set of context data, the host device 105 may take action such that the indicated portion is interpreted according to the different set of context data.

For example, the host device 105 may recognize a language element in the script indicating that a portion of the script is to be interpreted according to the local context data of a terminal device 120. The host device 105 may transmit the indicated portion of the script to the terminal device 120 for interpretation. Alternatively, the host device 105 may interpret the indicated portion of the script using local context data obtained from the terminal device 120. The host device 105 may receive the results of the interpretation according to the local context data of the terminal device 120 and continue interpreting the script according to the local context data of the host computing device 105 using the received results.

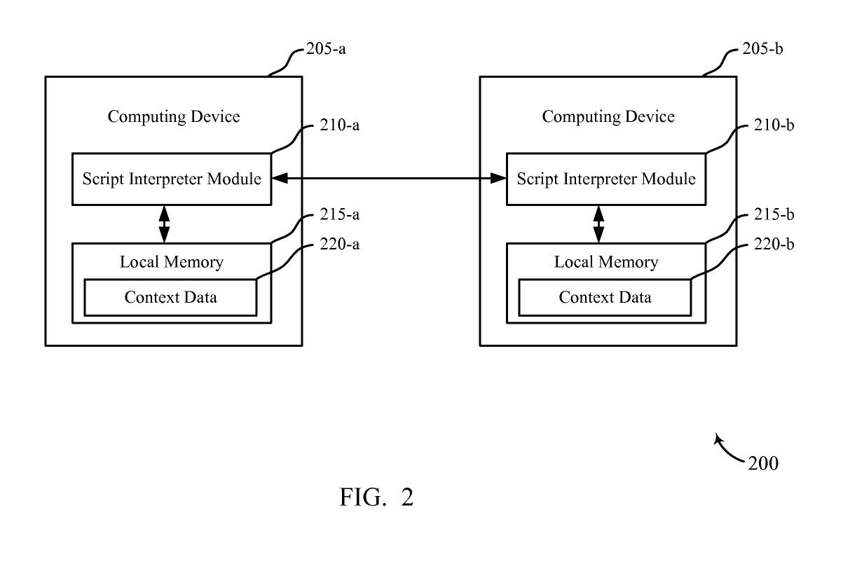

FIG. 2 is a block diagram of another example system 200 for remote context script interpretation according to the principles described herein. The system 200 of the present example includes a first computing device 205-a and a second computing device 205-b. The computing devices 205 may be communicatively coupled with each through a network link or by some other means.

The system 200 may be an example of the system 100 described above with reference to FIG. 1. In certain examples, the first computing device 205-a may be an example of one of the host devices 105 of FIG. 1 and the second computing device 205-b may be an example of one of the terminal devices 120 of FIG. 1. In certain examples, one or more central server computer systems (e.g., central server computer system 110, FIG. 1) or other network devices may be disposed along a communication path between the first and second computing devices 205.

Each of the computing devices 205 may include a script interpreter module 210 and a local memory 215 that contains context data 220 specific to that computing device 205. The local memory 215 may also store, among other data, one or more scripts to be interpreted by the script interpreter module 210-a. The script interpreter module 210-a of at least the first computing device 205-a may be configured to recognize a specific language element within the syntax of scripts that is associated with interpretation of a certain portion of the script in the context of the second computing device 205-b.

In one example, the script interpreter module 210-a of the first computing device 205-a may begin interpreting a script on the first computing device using the context data 220-a associated with the first computing device 205-a. However, a portion of the script may require variables or other information local to the second computing device 205-b to provide an accurate result. This portion of the script may be indicated by a specific language element in the syntax of the script that is recognized by the first computing device 205-a. Upon recognition of the language element, the first computing device 205-a may transfer the relevant part of the script to the second computing device 205-b, and the second computing device 205-b may interpret the indicated portion of the script using the context data 220-b associated with the second computing device 205-b. The second computing device 205-b may then return the results of its interpretation of the indicated portion of the script to the first computing device 205-a, and the first computing device 205-a may continue interpreting the script using the results received from the second computing device 205-b.

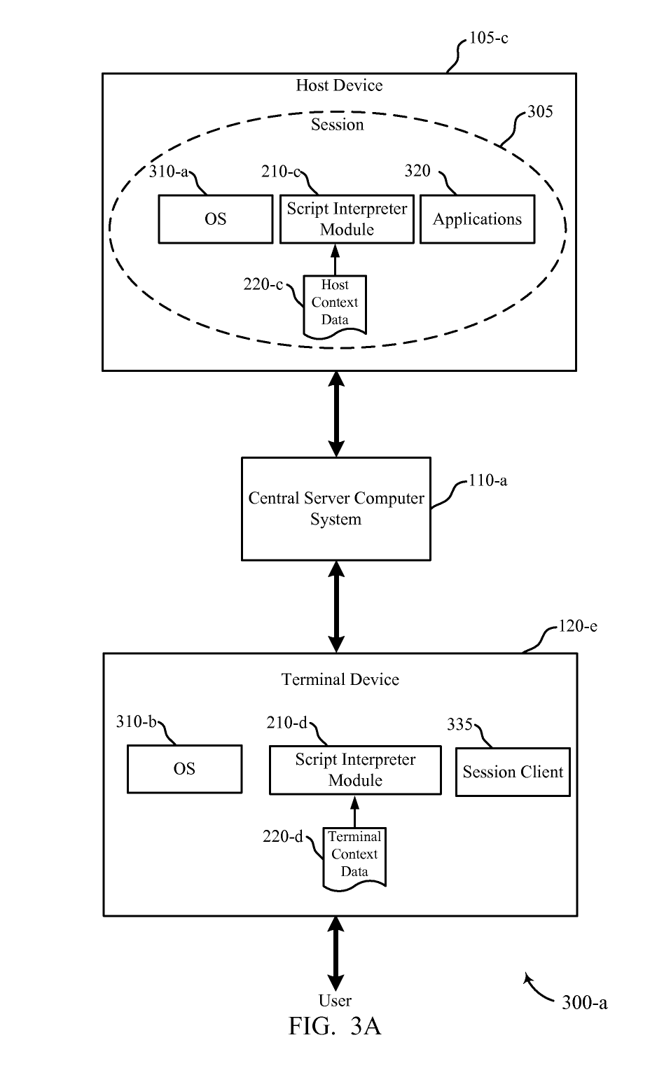

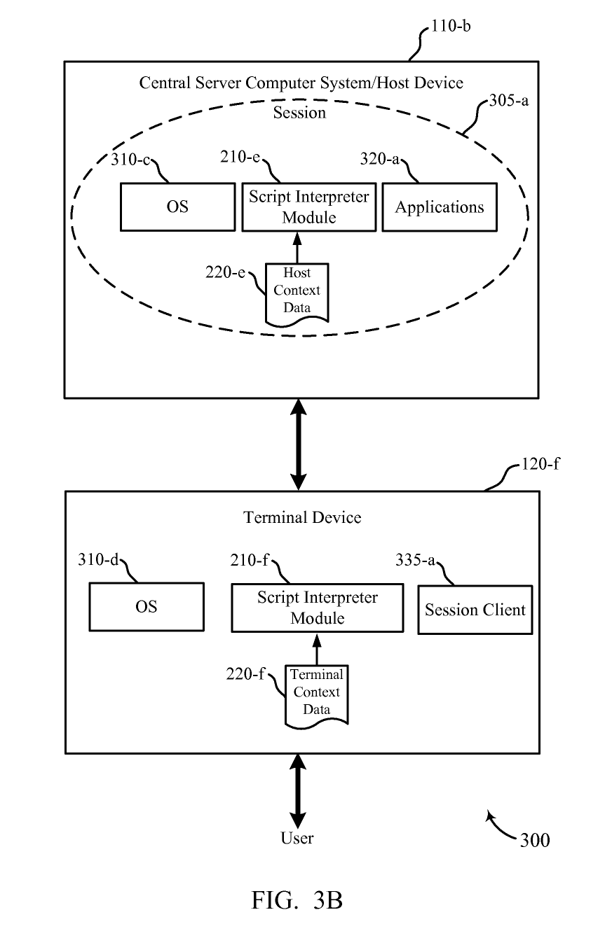

FIGS. 3A and 3B are block diagrams of example systems 300 for remote context script interpretation according to the principles described herein. The system 300-a of FIG. 3A includes a host device 105-c, a central server computer system 110-a, and a terminal device 120-e. The system 300-b of FIG. 3B includes a central server computer system 110-b and a terminal device 120-f, where the central server computer system 110-b also implements the functionality of a host device.

Each of the systems 300 of FIGS. 3A and 3B may be an example of the system 100 described above with respect to FIG. 1 or the system 200 described with respect to FIG. 2. Thus, the host device 105-c of FIG. 3A or the host device implemented by the central server computer system 110-b of FIG. 3B may be an example of one or more of the host devices 105 described in FIG. 1 or the computing devices 205 described in FIG. 2. Each of the central server computer systems 110 of FIGS. 3A and 3B may be an example of the central server computer system 110 described in FIG. 1 or one of the computing devices 205 described in FIG. 2. Each of the terminal devices 120 of FIGS. 3A and 3B may be an example of one or more of the terminal devices 120 described in FIG. 1 or one of the computing devices 205 described in FIG. 2.

The host device 105-c may be configured to establish and execute a virtual session 305 on behalf of a user of the terminal device 120-e. As executed at the host device 105-c, the session 305 may include implementations of an operating system 310-a, a script interpreter module 210-d, and a number of applications 320-a. The host device 105-c may also be configured to store host context data 220-c in local memory. The host context data 220-c may include a number of variables (e.g., location, type of device, device name, device capabilities, etc.) associated with the host device 105-c.

With reference to the example of FIG. 3A, the script interpreter module 210-c of the host device 105-c may be configured to interpret a script associated with the session 305, meaning that the script interpreter module 210-c carries out a series of commands. In certain examples, the script may be interpreted in response to a specific action, such as the user logging on or off of the terminal device 120-e or using an application 320 in connection with the session 305. Additionally or alternatively, the script may be interpreted at the expiration of a specified interval of time or in response to any other suitable trigger.

The terminal device 120-c may execute a session client 335 configured to communicate with the central server computer system 110-a and the host device 105-c to provide a user interface for the session 305 at the host device 105-c to a user of the terminal device 120-c. The terminal device 120-c may further be configured to execute at least an operating system 310-b and a script interpreter module 210-d. The script interpreter module 210-d may access terminal context data 220-d specific to and stored by the terminal device 120-c for use in script interpretation. The terminal context data 220-d may include a number of variables (e.g., location, type of device, device name, device capabilities, etc.) specific to the terminal device 120-c.

As described above, some portions of a script interpreted at the host device 105-c in connection with the session 305 may provide better results when interpreted in the context of the host device 105-c, and other portions of the script may provide better results when interpreted in the context of the terminal device 120-e. When the script interpreter module 210-c of the host device 105-c interprets a portion of the script in the context of the host device 105-c, the script interpreter module 210-c may use the variables or other information stored as host context data 220-c for the session 305. However, when a portion of the script is associated with a context of the terminal device 120-e, the host device 105-c may communicate with the terminal device 120-e to instruct the terminal device 120-e to interpret that portion of the script using the variables or other information stored as terminal context data 220-d.

Alternatively, the host device 105-c may obtain at least a subset of the terminal context data 220-f from the terminal device 120-f and interpret the indicated portion of the script using the obtained terminal context data 220-f.

The script syntax may define a language element which indicates the context in which a portion of the script is to be interpreted. In certain examples, the script may be executed in the context of the host device 105-c by default and in the context of the terminal device 120-e only where indicated by the language element.

With reference to the example of FIG. 3B, the script interpreter module 210-e of the host implemented by the central server computer system 110-b may be configured to interpret a script associated with the session 305-a, meaning that the script interpreter module 210-e carries out a series of commands. The terminal device 120-f may execute a session client 335-a configured to communicate with the central server computer system 110-b to provide a user interface for the session 305-a to a user of the terminal device 120-E The terminal device 120-f may further be configured to execute at least an operating system 310-d and a script interpreter module 210-f. The script interpreter module 210-f may access terminal context data 220-f specific to and stored by the terminal device 120-f for use in script interpretation. The terminal context data 220-f may include a number of variables (e.g., location, type of device, device name, device capabilities, etc.) specific to the terminal device 120-f.

As described above, when the script interpreter module 210-e of the central server computer system 110-b interprets a portion of the script in the context of the central server computer system 110-b, the script interpreter module 210-c may use the variables or other information stored as host context data 220-e for the session 305-a. However, when a portion of the script is associated with a context of the terminal device 120-f, the central server computer system 110-b may communicate with the terminal device 120-f to instruct the terminal device 120-f to interpret that portion of the script using the variables or other information stored as terminal context data 220-f.

Alternatively, the host device 105-c may obtain at least a subset of the terminal context data 220-f from the terminal device 120-f and interpret the indicated portion of the script using the obtained terminal context data 220-f.

The script syntax may define a language element which indicates the context in which a portion of the script is to be interpreted. In certain examples, the script may be executed in the context of the central server computer system 110-b by default and in the context of the terminal device 120-f only where indicated by the language element.

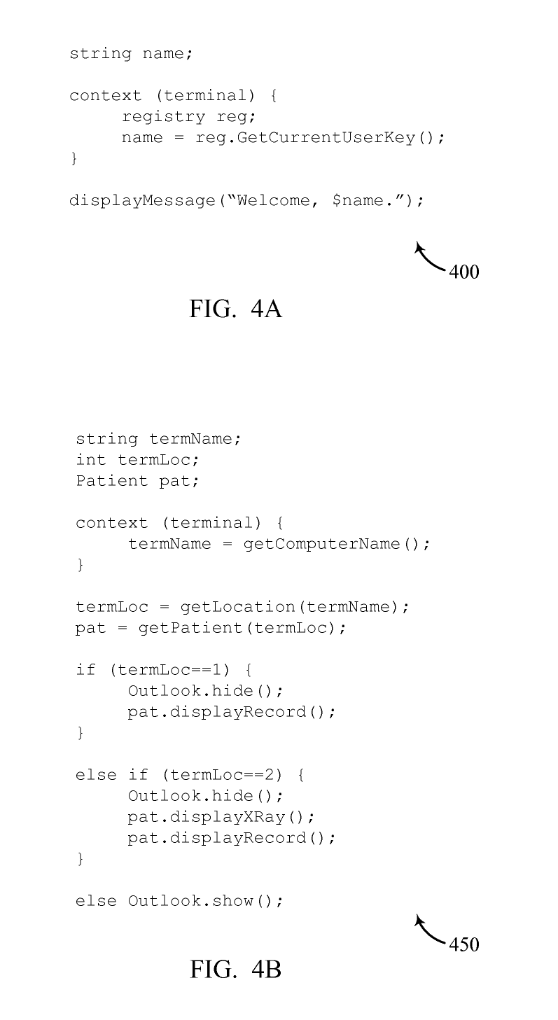

FIGS. 4A and 4B are each diagrams of a portion of a script associated with a virtual session, such as the virtual sessions 305 described above with reference to FIGS. 3A and 3B. The script portions shown in FIGS. 4A and 4B may be interpreted by a script interpreter module at a computing device, including one or more of the script interpreters 215 described above with reference to FIGS. 2, 3A, and 3B.

In the script language syntax of these examples, the keyword “context” may be used to indicate a portion of the script that are to be interpreted using context data other than a default. The portion may be indicated using a set of brackets surrounding the code of the script to be interpreted according to the remote context. In the case of FIGS. 4A and 4B, the default context may be that of the host device and/or central server computer system which hosts the virtual session and interprets the scripts. The scripts illustrated in FIGS. 4A and 4B may be interpreted, for example, when a virtual session is initiated or when a user accesses a virtual session from a new terminal device.

In the example script portion 450 of FIG. 4A, the string variable name is initialized. Then, the keyword context and input terminal indicate that the portion of the script found within the following set of brackets is to be interpreted in the context of the terminal device. Thus, within the context of the terminal device, a registry variable reg is initialized. Because the registry variable is initialized within the context of the terminal device, the registry variable reg may represent a copy of the registry of the terminal device rather than the host device. Still within the context of the terminal device, the string variable name is set to the value of the current user key of the registry variable. That is, name is set to the user key associated with the registry of the terminal device. Returning to the context of the host device, a welcome message is displayed in the session with the value of the name variable.

In certain examples, interpreting the portion of the script indicated by the context keyword may entail the host device or central server computer system transmitting the code within the brackets, together with any relevant local context information of the host device or central server computer system, to the terminal device. The terminal device may then return the reg and/or name variables, or the values of these variables, to the host device or central server computer system. Alternatively, the central server computer system or host device may interpret the indicated portion of the script by communicating with the terminal device to request a current user key of the registry of the terminal device and setting the name variable equal to the user key received from the terminal device in response to the request.

The local registry of the terminal device may be used by the host device or central server computer device in accordance with these techniques for a number of reasons. In another example, the host device or central server computer system may be hosting a session application on behalf of a user of the terminal device. The session application may rely on various registry entries of the terminal device to determine a configuration of the session application functionality and user interface. Rather than store and maintain a local copy of every registry for every possible terminal device at the host device or central server computer system, a script may be interpreted at the host device or central server computer system in the context of the terminal device to configure the session application based on the relevant portions of the local registry of the terminal device.

In the example script portion of FIG. 4B, a string variable termName, an integer variable termLoc, and a Patient variable pat may be initialized. Then, within the context of the terminal device currently associated with the session, termName may be set to the current computer name. That is, termName is set to the name of the terminal device rather than the name of the host device or server running the script. Returning to the context of the host device, a current location of the terminal device may be determined by querying a database using termName, and a patient associated with the current location may be determined based on the current location by querying the database using getPatient. Then, different actions may be taken with respect to the user interface of a current session based on the current location. In the present example these actions may include showing or hiding an Outlook window, displaying medical records for the patient associated with the current location, and displaying X-Ray records for the patient.

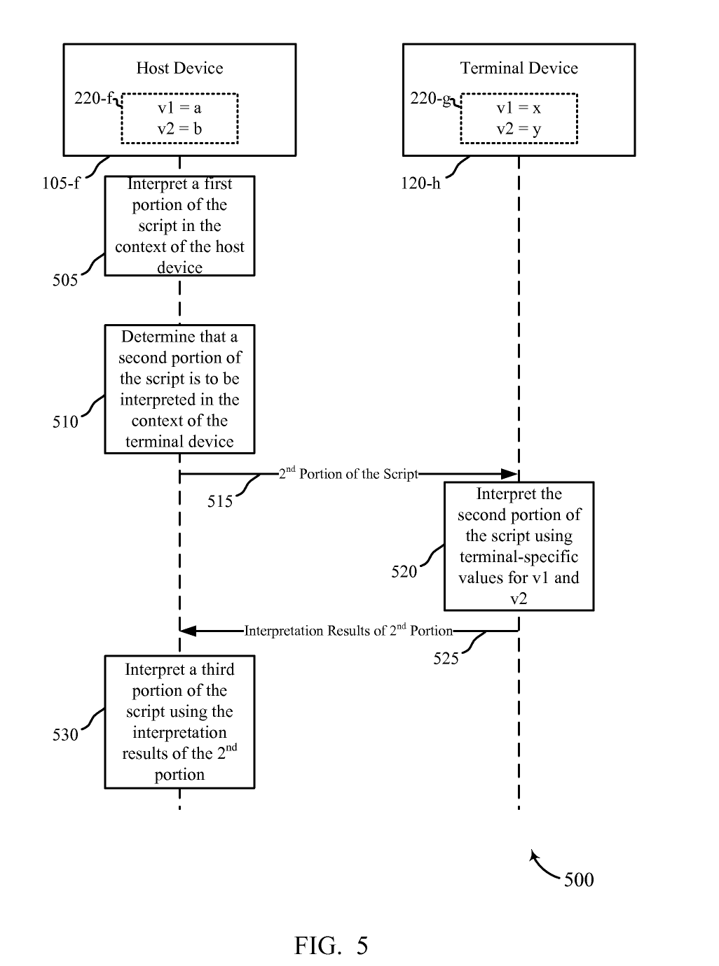

FIG. 5 is a diagram of an example of communication flow 500 between a host device 105-f and a terminal device 120-h during the interpretation of a script. The host device 105-f may be an example of one or more of the host devices 105 or central server computer systems 110 described above with reference to previous Figures. The terminal device 120-h may be an example of one or more of the terminal devices 120 described above with reference to previous Figures. The host device 105-f and terminal device 120-h may be communicatively coupled with each other through, for example, a network connection. In certain examples, one or more intermediate devices may be situated along the path of communication between the host device 105-f and the terminal device 120-h.

Each of the host device 105-f and the terminal device 120-h may store a set of local context data. In the present example, the host device stores a first set of values for variables v1 and v2, and the terminal device stores a second set of values for variables v1 and v2. It will be understood that these variables may represent any variable that may be relevant to the interpretation of a script, including variables at the application, operating system, network, or machine level of the host device 105-f or the terminal device 120-h.

At block 505, the host device 105-f may begin interpreting a script by interpreting a first portion of the script in the context of the host device 105-f. In other words, the host device 105-f may use the local context data 220-f of the host device 105-f to interpret the first portion of the script.

At block 510, the host device 105-f may determine that a second portion of the script is to be interpreted in the context of the terminal device. As discussed above, this determination may be made by identifying a keyword in the script that indicates the portion of the script to be interpreted in the context of the terminal device 120-h. The keyword may, for example, be associated with brackets or other delineating characters that identify lines of code in the script to be interpreted in the context of the terminal device 120-h. The keyword may additionally be associated with parentheses or other delineating characters that identify the terminal device 120-h in association with the indicated second portion of the script.

The host device 105-f may accordingly transmit 515 the second portion of the script to the terminal device 120-h for interpretation. At block 520, the terminal device 120-h may interpret the second portion of the script using, for example, the values of v1 and v2 from the local context data of the terminal device 120-h. The terminal device 120-h may then return 525 the results of the interpretation of the second portion of the script to the host device 105-f. At block 530, the host device 105-f may interpret a third portion of the script using the interpretation results received from the terminal device 120-h.

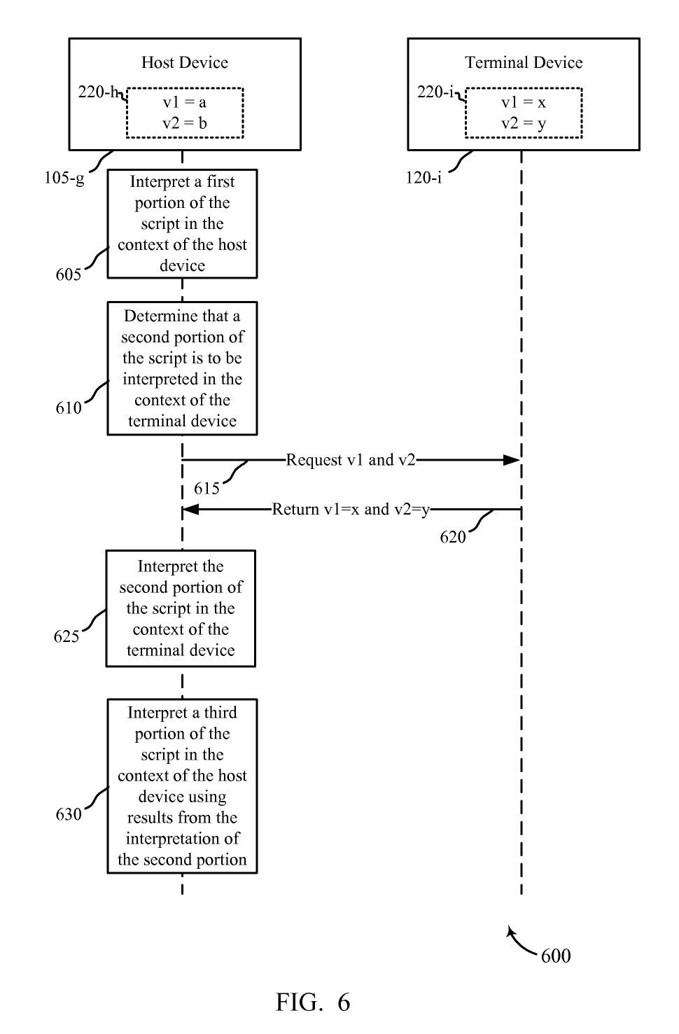

FIG. 6 is a diagram of another example of communication flow 600 between a host device 105-g and a terminal device 120-i during the interpretation of a script. The host device 105-g may be an example of one or more of the host devices 105 or central server computer systems 110 described above with reference to previous Figures. The terminal device 120-i may be an example of one or more of the terminal devices 120 described above with reference to previous Figures. The host device 105-g and terminal device 120-i may be communicatively coupled with each other through, for example, a network connection. In certain examples, one or more intermediate devices may be situated along the path of communication between the host device 105-g and the terminal device 120-i.

Each of the host device 105-g and the terminal device 120-i may store a set of local context data. In the present example, the host device stores a first set of values for variables v1 and v2, and the terminal device stores a second set of values for variables v1 and v2. It will be understood that these variables may represent any variable that may be relevant to the interpretation of a script, including variables at the application, operating system, network, or machine level of the host device 105-g or the terminal device 120-i.

At block 605, the host device 105-g may begin interpreting a script by interpreting a first portion of the script in the context of the host device 105-g. In other words, the host device 105-g may use the local context data 220-h stored by the host device 105-g to interpret the first portion of the script.

At block 610, the host device 105-g may determine that a second portion of the script is to be interpreted in the context of the terminal device 120-i. As discussed above, this determination may be made by identifying a keyword in the script that indicates the portion of the script to be interpreted in the context of the terminal device 120-i. The keyword may, for example, be associated with brackets or other delineating characters that identify lines of code in the script to be interpreted in the context of the terminal device 120-i. The keyword may additionally be associated with parentheses or other delineating characters that identify the terminal device 120-i in association with the indicated second portion of the script.

In the present example, the second portion of the script may reference variables v1 and v2. The host device 105-g may accordingly transmit 615 a request for the values of v1 and v2 stored locally by the terminal device 120-i. The terminal device 120-i may return 620 the locally stored values of v1 and v2 to the host device 105-f. At block 625, the host device 105-g may interpret the second portion of the script in the context of the terminal device 120-i, that is, using the values of v1 and v2 received from the terminal device 120-i rather than the values of v1 and v2 associated with the local context of the host device 105-g. At block 630, the host device 105-g may interpret a third portion of the script in the context of the host device 105-g using the results of the second portion of the script that was interpreted in the context of the terminal device 120-i.

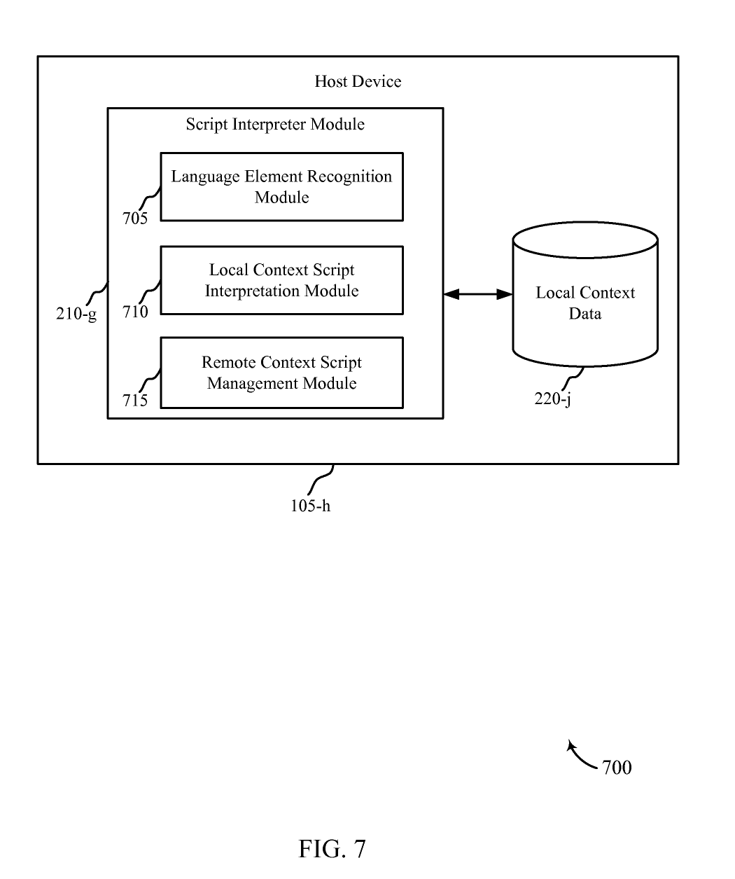

FIG. 7 is a block diagram 700 of an example host device 105-h according to the principles of the present disclosure. The host device 105-h may include a script interpreter module 210-g and a data store of local context data 220-j for the host device 105-h. Each of these elements may be in communication, directly or indirectly. The host device 105-d may be an example of one or more of the host devices 105, central server computer systems 110, or other computing devices 205 described above with reference to the previous Figures.

The script interpreter module 210-g may include a language element recognition module 705, a local context script interpretation module 710 and a remote context script management module 715. The language element recognition module may recognize language elements, such as keywords, and other semantic or syntactic cues in the script and translate the recognized language elements into actions to be taken by the host device. The local context script interpretation module 710 may perform identified actions using local context data 220-j stored by the host device 105-h to interpret portions of the script, and the remote context script management module 715 may perform actions or cause actions to be performed in the context of an identified remote device.

As part of this process, the language element recognition module 705 of the script interpreter module 210-g may recognize a keyword or other language element within the script which indicates script interpretation within a remote context. In certain examples, the keyword or other language element may be associated with a set of parentheses. The parentheses may indicate an identity of a remote computing device (e.g., remote terminal device 120 or computing device 205 of the previous Figures). If the portions of the script to be interpreted in the context of the remote terminal device are greater than one line in length, the keyword may also be associated with a set of brackets enclosing the portion of the script which is to be interpreted in the context of the remote terminal device.

The remote context script management module 715 may communicate with the identified remote device to cause the remote device to interpret the indicated portion of the script in the context of the remote device or another indicated remote device. The remote context script management module 715 may receive results from the remote device associated with the interpretation of the indicated portion of the script in the context of the remote device. These received results may be used by the local context script interpretation module 710 to continue interpreting the remainder of the script at the host device 105-h. Alternatively, the remote context script management module 715 may request context data local to the remote device and relevant to the indicated portion of the script, receive the requested context data from the remote device, and interpret the indicated portion of the script using the received context data from the remote device.

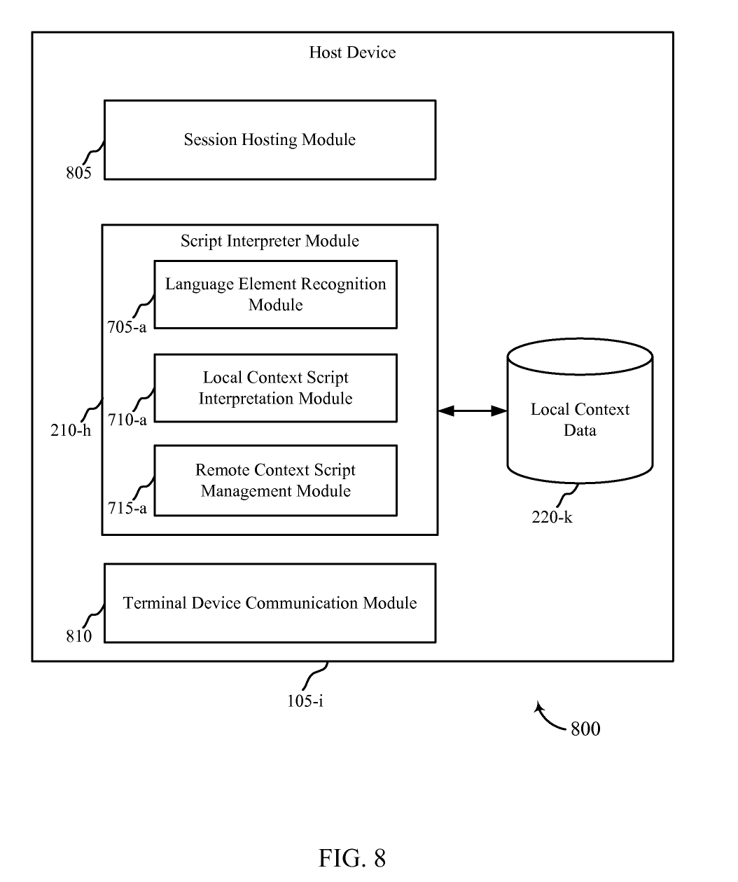

FIG. 8 is a block diagram 800 of another example of a host device 105-i according to the principles of the present disclosure. The host device 105-i may include a session hosting module 805, a script interpreter module 210-h, a terminal device communication module 105-i, and a data store of local context data 220-k. Each of these elements may be in communication, directly or indirectly. The host device 105-i may be an example of one or more of the host devices 105, central server computer systems 110, or other computing devices 205 described above with reference to the previous Figures.

The session hosting module 805 may be configured to execute and host a virtual session for a user of one or more remote terminal devices (e.g., a terminal device 120 of one or more of the previous Figures). The terminal device communication module 810 may be configured to provide a user interface of the virtual session to the remote terminal device over a network connection.

The script interpreter module 210-h may include a language element recognition module 705-a, a local context script interpretation module 710-a and a remote context script management module 715-a. The language element recognition module 705-a may recognize language elements, such as keywords, and other semantic or syntactic cues in the script and translate the recognized language elements into actions to be taken by the host device. The local context script interpretation module 710-a may perform identified actions using local context data 220-h stored by the host device 105-i to interpret portions of the script, and the remote context script management module 715-a may perform actions or cause actions to be performed in the context of an identified remote device.

As part of this process, the language element recognition module 705-a of the script interpreter module 210-h may recognize a keyword or other language element within the script which indicates script interpretation within a remote context. In certain examples, the keyword or other language element may be associated with a set of parentheses. The parentheses may indicate an identity of a remote computing device (e.g., remote terminal device 120 or computing device 205 of the previous Figures). If the portions of the script to be interpreted in the context of the remote terminal device are greater than one line in length, the keyword may also be associated with a set of brackets enclosing the portion of the script which is to be interpreted in the context of the remote terminal device.

The remote context script management module 715-a may communicate with the identified remote device to cause the remote device to interpret the indicated portion of the script in the context of the remote device or another indicated remote device. The remote context script management module 715-a may receive results from the remote device associated with the interpretation of the indicated portion of the script in the context of the remote device. These received results may be used by the local context script interpretation module 710-a to continue interpreting the remainder of the script at the host device 105-i. Alternatively, the remote context script management module 715-a may request context data local to the remote device and relevant to the indicated portion of the script, receive the requested context data from the remote device, and interpret the indicated portion of the script using the received context data from the remote device.

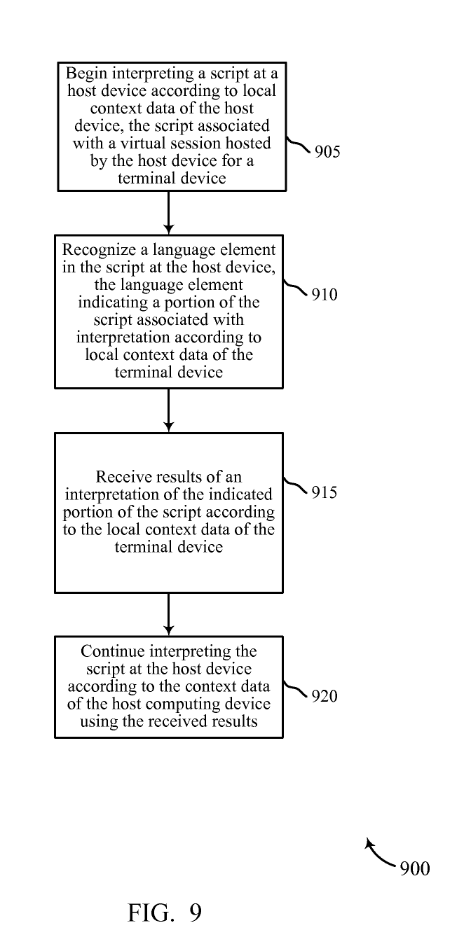

FIG. 9 illustrates a flowchart of an example method 900 of dynamically interpreting a script in a remote context. The method 900 may be performed, for example, by one or more of the host devices 105, central server computer systems 110, or computing devices 205 described above with reference to the previous Figures.

At block 905, a host device may begin interpreting a script according to local context data of the host device. The script may be associated with a virtual session hosted by the host device for a terminal device. At block 910, the host computing device may recognize a language element in the script, the language element indicating a portion of the script associated with interpretation according to local context data of the terminal device. At block 915, the host computing device may receive results of an interpretation of the indicated portion of the script according to the local context data of the terminal device. In certain examples, the results may be received from the terminal device. Alternatively, the host device may interpret the indicated portion of the script using local context data obtained from the terminal device. At block 920, the host device may continue interpreting the script according to the context data of the host computing device using the received results.

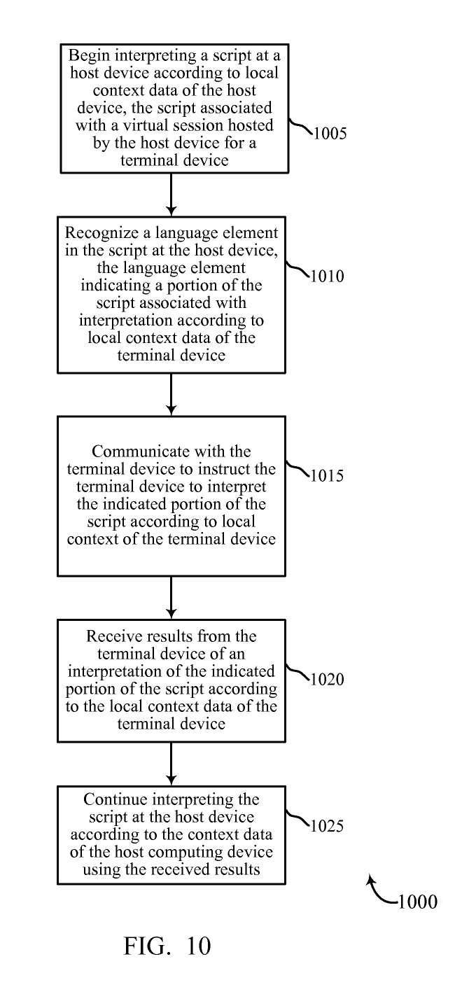

FIG. 10 illustrates a flowchart of another example method 1000 of dynamically interpreting a script in a remote context. The method 1000 may be performed, for example, by one or more of the host devices 105, central server computer systems 110, or computing devices 205 described above with reference to the previous Figures.

At block 1005, a host device may begin interpreting a script according to local context data of the host device. The script may be associated with a virtual session hosted by the host device for a terminal device. At block 1010, the host computing device may recognize a language element in the script, the language element indicating a portion of the script associated with interpretation according to local context data of the terminal device. At block 1015, the host device may communicate with the terminal device to instruct the terminal device to interpret the indicated portion according to a local context of the terminal device. At block 1020, the host computing device may receive from the terminal device the results of the interpretation of the indicated portion of the script according to the local context data of the terminal device. At block 1025, the host device may continue interpreting the script according to the context data of the host computing device using the received results.

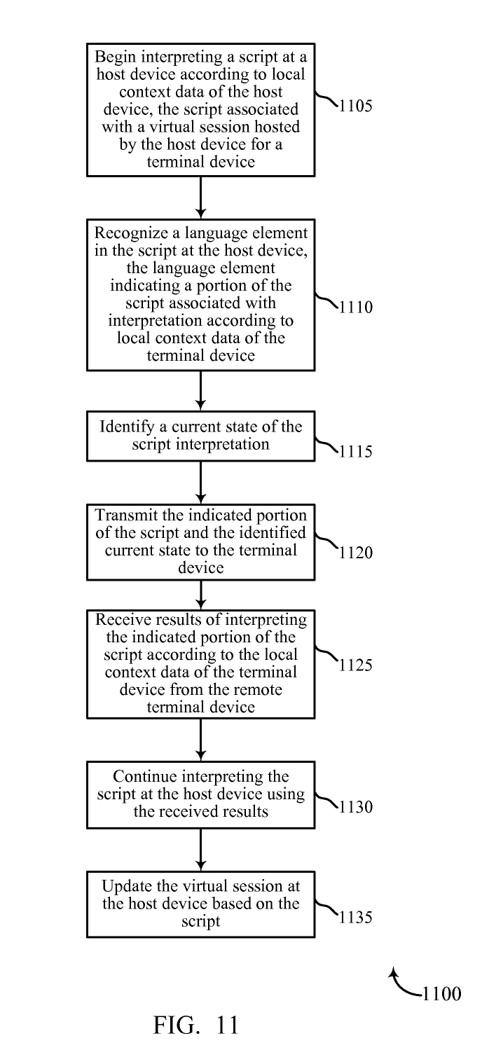

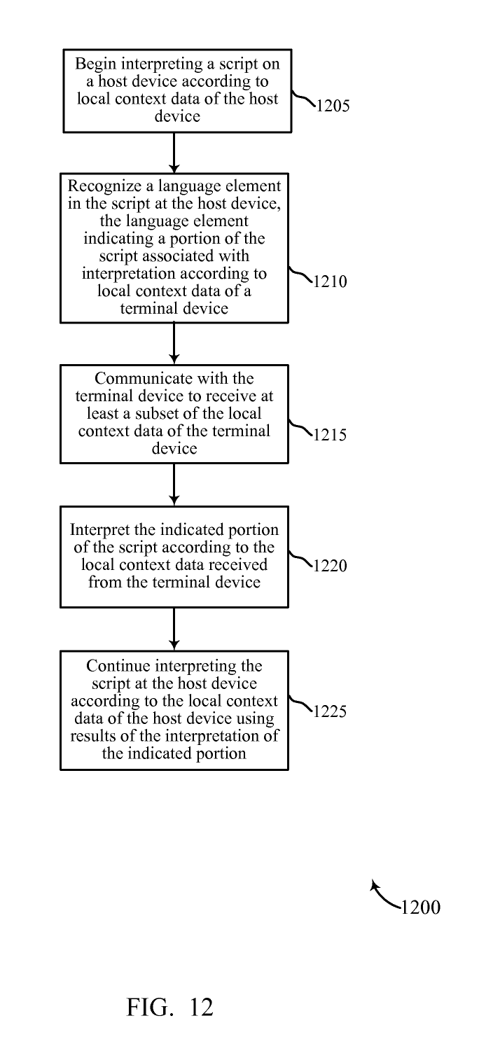

FIG. 11 illustrates a flowchart of another example method 1100 of dynamically interpreting a script in a remote context. The method 1100 may be performed, for example, by one or more of the host devices 105, central server computer systems 110, or computing devices 205 described above with reference to the previous Figures.

At block 1105, a host device may begin interpreting a script according to local context data of the host device. The script may be associated with a virtual session hosted by the host device for a terminal device. At block 1110, the host computing device may recognize a language element in the script, the language element indicating a portion of the script associated with interpretation according to local context data of the terminal device.

At block 1115, the host device may identify a current state of the script interpretation. The current state may include a current point or location within the script at which interpretation is occurring, a current value of one or more variables associated with the script, a current configuration of an application associated with the script, parameters that have been input to or output from the script, or other elements of a current state of the script interpretation. At block 1120, the host device may transmit the indicated portion of the script and at least a subset of the identified current state of the script interpretation to the terminal device. At block 1125, the host device may receive from the terminal device the results of the interpretation of the indicated portion of the script according to the local context data of the terminal device. At block 1130, the host device may continue interpreting the script according to the context data of the host computing device using the received results. At block 1135, the host device may update the virtual session based on the interpretation of the script.

FIG. 12 illustrates a flowchart of another example method 1200 of dynamically interpreting a script in a remote context. The method 1200 may be performed, for example, by one or more of the host devices 105, central server computer systems 110, or computing devices 205 described above with reference to the previous Figures.

At block 1205, a host device may begin interpreting a script on a host device according to local context data of the host device. At block 1210, the host device may recognize a language element in the script, the language element indicating a portion of the script associated with interpretation according to local context data of a terminal device.

At block 1215, the host device may communicate with the terminal device to receive at least a subset of the local context data of the terminal device. In certain examples, the host device may determine the subset of the local context data of the terminal device based on what is relevant to the interpretation of the indicated portion of the script. At block 1220, the host device may interpret the indicated portion of the script according to the local context data received from the terminal device. At block 1225, the host device may continue interpreting the script according to the context data of the host computing device using the results of the interpretation of the indicated portion.

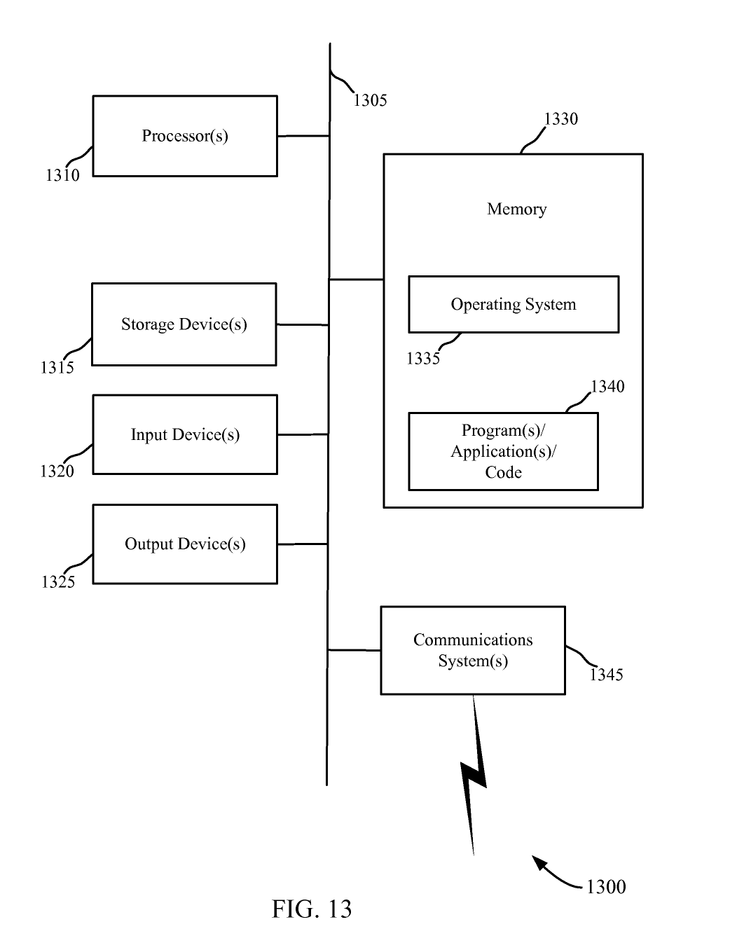

A device structure 1300 that may be used for a host device 105, a central server computer system 110, a rules engine 115, a terminal device 120, or other computing devices 205 described herein, is illustrated with the schematic diagram of FIG. 13. This drawing broadly illustrates how individual system elements of each of the aforementioned devices may be implemented, whether in a separated or more integrated manner. The exemplary structure is shown comprised of hardware elements that are electrically coupled via bus 1305, including processor(s) 1310 (which may further comprise a DSP or special-purpose processor), storage device(s) 1315, input device(s) 1320, and output device(s) 1325. The storage device(s) 1315 may be a machine-readable storage media reader connected to any machine-readable storage medium, the combination comprehensively representing remote, local, fixed, or removable storage devices or storage media for temporarily or more permanently containing computer-readable information. The communications systems interface 1345 may interface to a wired, wireless, or other type of interfacing connection that permits data to be exchanged with other devices. The communications system(s) interface 1345 may permit data to be exchanged with a network.

The structure 1300 may also include additional software elements, shown as being currently located within working memory 1330, including an operating system 1335 and other code 1340, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

These components may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs) and other Semi-Custom ICs), which may be programmed in any manner known in the art. The functions of each unit may also be implemented, in whole or in part, with instructions embodied in a memory, formatted to be executed by one or more general or application-specific processors.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a SIM card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A system for managing virtual sessions, comprising:
a terminal device; and
a host device communicatively coupled with the terminal device over a network, the host device configured to:
begin interpreting a script according to local context data of the host device, the script associated with a virtual session hosted by the host device on behalf of the terminal device;
recognize a language element in the script, the language element indicating a portion of the script associated with script interpretation according to local context data of the terminal device;
receive results of an interpretation of the indicated portion of the script according to the local context data of the terminal device; and
continue to interpret the script according to the context data of the host computing device using the received results.

2. The system of claim 1, the host device further configured to:
communicate with the terminal device over the network to instruct the terminal device to interpret the indicated portion of the script according to the local context of the terminal device.

3. The system of claim 2, the host device further configured to:
receive the results of the interpretation of the indicated portion of the script from the terminal device over the network.

4. The system of claim 1, the host device further configured to:
communicate with the terminal device to receive at least a subset of the local context data of the terminal device; and
interpret the indicated portion of the script using the received subset of the local context data of the terminal device.

5. A method of managing virtual sessions, comprising:
beginning an interpretation of a script at a host device according to local context data of the host device, the script associated with a virtual session hosted by the host device on behalf of a terminal device communicatively coupled with the host computing device;
recognizing a language element in the script at the host device, the language element indicating a portion of the script associated with interpretation according to local context data of the terminal device;
receiving results of an interpretation of the indicated portion of the script according to the local context data of the terminal device; and
continuing to interpret the script at the host device according to the context data of the host computing device using the received results.

6. The method of claim 5, further comprising:
communicating with the terminal device to instruct the terminal device to interpret the indicated portion of the script according to the local context of the terminal device.

7. The method of claim 6, further comprising:
transmitting the indicated portion of the script from the host device to the terminal device.

8. The method of claim 6, further comprising:
identifying a current state of the script interpretation; and
transmitting the identified current state of the script interpretation from the host device to the terminal device in response to the determination.

9. The method of claim 6, further comprising:
receiving the results of the interpretation of the indicated portion of the script from the terminal device over a network.

10. The method of claim 5, further comprising:
communicating with the terminal device to receive at least a subset of the local context data of the terminal device.

11. The method of claim 10, further comprising:
interpreting the indicated portion of the script at the host device using the received subset of the local context data of the terminal device.

12. The method of claim 5, wherein the local context of the terminal device comprises at least one local variable associated with the terminal device.

13. A host device, comprising:
at least one processor; and
a memory communicatively coupled with the at least one processor, the memory storing code that, when executed by the at least one processor, causes the at least one processor to:
begin interpreting a script according to local context data of the host device, the script associated with a virtual session hosted by the host device on behalf of a terminal device communicatively coupled with the host computing device;
recognize a language element in the script, the language element indicating a portion of the script associated with interpretation according to local context data of the terminal device;
receive results of an interpretation of the indicated portion of the script according to the local context data of the terminal device; and
continue to interpret the script according to the context data of the host computing device using the received results.

14. The host device of claim 13, wherein the code further causes the at least one processor to:
communicate with the terminal device to instruct the terminal device to interpret the indicated portion of the script according to the local context of the terminal device.

15. The host device of claim 14, wherein the code further causes the at least one processor to:
transmit the indicated portion of the script from the host device to the terminal device.

16. The host device of claim 14, wherein the code further causes the at least one processor to:
determine that interpretation of the indicated script is dependent on at least one value stored locally at the host device; and
transmit the at least one value from the host device to the terminal device in response to the determination.

17. The host device of claim 14, wherein the code further causes the at least one processor to:
receive the results of the interpretation of the indicated portion of the script from the terminal device over a network.

18. The host device of claim 13, wherein the code further causes the at least one processor to:
communicate with the terminal device to receive at least a subset of the local context data of the terminal device.

19. The host device of claim 18, wherein the code further causes the at least one processor to:
interpret the indicated portion of the script at the host device using the received subset of the local context data of the terminal device.

20. The host device of claim 13, wherein the local context of the terminal device comprises at least one local variable associated with the terminal device.
